(19) United States
(12) Patent Application Publication
(10) Pub. No.: US 2024/0316964 A1
(43) Pub. Date: Sep. 26, 2024

(54) PRINTING DEVICE AND PRINTING METHOD

(71) Applicant: SEIKO EPSON CORPORATION, Tokyo (JP)

(72) Inventor: Kazuyoshi TANASE, MATSUMOTO-SHI (JP)

(21) Appl. No.: 18/610,357

(22) Filed: Mar. 20, 2024

(30) Foreign Application Priority Data
Mar. 23, 2023 (JP) 2023-046395

(51) Int. Cl. B41J 25/316; B41J 2/045; B41J 25/00

(52) U.S. Cl. CPC B41J 25/316; B41J 2/04505; B41J 2/04586; B41J 25/001

(57) ABSTRACT

A printing device includes a head having a nozzle array R in which a plurality of nozzles N are arranged in a first direction E, a movement mechanism that relatively moves the head and the printing medium M when ink I is ejected onto the printing medium M, a head angle adjustment section having a base plate, a head holding section that is pivotable, and a drive section, and configured to change an inclination angle θ of the first direction E with respect to a direction orthogonal to a relative movement direction B, wherein the head holding section is pivoted with respect to the base plate, by controlling the drive section, such that, when forming an image in a predetermined area of the printing medium M with a plurality of passes, the inclination angle θ is different between a first pass and a second pass.

The present application is based on, and claims priority from JP Application Serial Number 2023-046395, filed Mar. 23, 2023, the disclosure of which is hereby incorporated by reference herein in its entirety.

### BACKGROUND

### 1. Technical Field

The present disclosure relates to a printing device and a printing method.

### 2. Related Art

In the related art, various printing devices that perform printing by ejecting ink onto a printing medium are used. For example, JP-A-2017-81091 discloses a printer capable of ejecting ink onto a sheet to perform printing.

With such a printing device, depending on the type of printing medium used, the ink ejected onto the printing medium may cause the medium to swell. When the printing medium swells due to the ink ejected onto the printing medium, the ink may land at a position different from a desired position in association with the swelling of the printing medium when another ink is subsequently ejected or when the ink is ejected in a subsequent pass in the case of forming an image in a plurality of passes. There is a concern that if ink lands on a position different from the desired position, blurring may occur in the image. Here, the printer of JP-A-2017-81091 has a configuration in which banding can be suppressed by changing the recording head to be used among the recording heads, which are arranged in a staggered manner. However, blurring or the like may occur in some cases in the image, in particular, when a printing medium on which ink does not easily wet and spread is used or when a printing medium that easily swells is used.

### SUMMARY

In order to solve the above-described problem, a printing device includes a head having a nozzle array in which a plurality of nozzles configured to eject ink onto a printing medium are arranged in a first direction, a movement mechanism that relatively moves the head and the printing medium when ink is ejected onto the printing medium, a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium, and a control section, wherein the control section controls the drive section to rotate the head holding section with respect to the base plate such that, when forming an image in a predetermined area of the printing medium with a plurality of passes, the inclination angle is different between a first pass of the plurality of passes and a second pass different from the first pass of the plurality of passes.

Another printing device, according to the present disclosure for solving the above problems, includes a transport section that transports printing medium, a first head that is disposed at a position facing an image forming surface of the printing medium in a transport path of the printing medium and that includes a first nozzle row in which a plurality of nozzles for ejecting ink onto the printing medium are formed arranged in a first direction, a second head that is disposed at a position facing the image forming surface in the transport path and downstream of the first head in the transport direction of the printing medium and that includes a second nozzle row in which a plurality of nozzles for ejecting ink onto the printing medium are formed arranged in a second direction, a first head angle adjustment section having a first base plate, a first head holding section that is pivotable around a first pivot axis with respect to the first base plate in a state of holding the first head, and a first drive section that pivots the first head holding section around the first pivot axis, and configured to change a first inclination angle, which is an inclination angle of the first direction with respect to a direction orthogonal to the transport direction, a second head angle adjustment section including a second base plate, a second head holding section that is pivotable around a second pivot axis with respect to the second base plate in a state of holding the second head, and a second drive section that pivots the second head holding section around the second pivot axis, and configured to change a second inclination angle, which is an inclination angle of the second direction with respect to a direction orthogonal to the transport direction, and a control section, wherein the control section performs at least one of controlling the first drive section to pivot the first head holding section with respect to the first base plate or controlling the second drive section to pivot the second head holding section with respect to the second base plate such that the first inclination angle and the second inclination angle are different when an image is formed.

In present disclosure, a printing method of the printing device, according to solve the above problems, including a head having a nozzle array in which a plurality of nozzles configured to eject ink onto a printing medium are arranged in a first direction, a movement mechanism that relatively moves the head and the printing medium when the ink is ejected onto the printing medium, and a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium, the printing method includes pivoting the head holding section with respect to the base plate such that the inclination angle is different between a first pass among the plurality of passes and a second pass different from the first pass among the plurality of passes when forming an image in a predetermined area of the printing medium with a plurality of passes.

### BRIEF DESCRIPTION OF THE DRAWINGS

FIG. 1 is a schematic plan view of a printing device according to a first embodiment of the present disclosure and is a diagram transparently illustrating positions of nozzles in a head.

FIG. 2 is a schematic perspective view illustrating a head holding section of the printing device according to the first embodiment.

FIG. 3 is a schematic illustrating a manner in which a linear pattern is printed on a printing medium that tends not to swell with the printing device according to the first embodiment, and is a diagram illustrating a formation state of the linear pattern in a case where an inclination angle is 0°, which is the smallest in both the first and second passes.

FIG. 4 is a schematic illustrating a manner in which a linear pattern is printed on a printing medium that is likely to swell with the printing device according to the first embodiment and is a diagram illustrating a formation state of the linear pattern in a case where an inclination angle is 0°, which is the smallest in both the first and second passes.

FIG. 5 is a schematic illustrating a state in which a linear pattern is printed on a printing medium that easily swells by the printing device according to the first embodiment, and is a diagram illustrating a formation state of the linear pattern in a case where an inclination angle is large in a first pass and the inclination angle is 0°, which is the minimum in a second pass.

FIG. 6 is a diagram explaining a method for determining an inclination angle in the printing device according to the first embodiment.

FIG. 7 is a schematic plan view of a printing device according to a second embodiment of the disclosure, showing the positions of nozzles in a transparent view of a head.

FIG. 8 is a schematic plan view of a printing device according to a third embodiment of the disclosure, showing the positions of nozzles in a transparent view of a head.

### DESCRIPTION OF EMBODIMENTS

First, the present disclosure will be schematically described. In order to solve the above-described problem, a printing device, according to a first aspect of the present disclosure, includes a head having a nozzle array in which a plurality of nozzles configured to eject ink onto a printing medium are arranged in a first direction, a movement mechanism that relatively moves the head and the printing medium when ink is ejected onto the printing medium, a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium, and a control section, wherein the control section controls the drive section to rotate the head holding section with respect to the base plate such that, when forming an image in a predetermined area of the printing medium with a plurality of passes, the inclination angle is different between a first pass of the plurality of passes and a second pass different from the first pass of the plurality of passes.

According to this aspect, a head angle adjustment section changeable an inclination angle is provided, and when an image is formed in a predetermined region of the printing medium in a plurality of passes, the head holding section is rotated with respect to the base plate so that the inclination angle differs between the first pass and the second pass among the plurality of passes. Therefore, for example, even if the printing medium swells due to ink ejected onto the printing medium in the first pass, increasing the inclination angle to narrow the printing width in the first pass in printing in the first pass and decreasing the inclination angle to widen the printing width in the second pass in printing in the second pass can reduce the displacement of the ink landing position in the second pass relative to the ink landing position in the first pass even if the printing width is widened due to the swelling of the printing medium after the end of printing in the first pass. Therefore, it is possible to suppress the occurrence of blurring or the like in an image because of the expansion and the contraction of the printing medium caused by the landing of ink.

A printing device of a second aspect of the present disclosure, according to the first aspect, the printing device further includes a storage section, wherein the storage section stores, for each of the first and second passes, an inclination angle determined in advance based on type of printing medium, an ejection amount of ink to be ejected per pass, and a number of passes representing how many passes in which ink is ejected per unit area and the control section determines a set inclination angle, from the inclination angles stored in the storage section, based on the type of printing medium to be used in formation of the image, the ejection amount of ink to be ejected per pass in formation of the image, and the number of passes in formation of the image, and controls the drive section based on the set inclination angle.

According to this aspect, the storage section stores, for each of the first and second passes, the inclination angle determined in advance based on the type of the printing medium, the ejection amount of the ink ejected per pass, and the number of passes indicating the number of passes in which the ink is ejected per unit area. So, the control section determines the set inclination angle from the inclination angle stored in the storage section based on the type of the printing medium used when forming the image, the ejection amount of the ink ejected per pass when forming the image, and the number of passes when forming the image, and controls the drive section based on the set inclination angle. That is, it is possible to easily and accurately determine the preferable set inclination angle by storing the degree of expansion and contraction of the printing medium due to the ink that is ejected onto the printing medium along with the printing of the first pass in the storage section in advance for each of the conditions with respect to the first and second passes. Therefore, it is possible to suppress the time and effort required by the user and the complexity of the control section's control.

A printing device according to a third aspect of the present disclosure includes a transport section that transports printing medium, a first head that is disposed at a position facing an image forming surface of the printing medium in a transport path of the printing medium and that includes a first nozzle row in which a plurality of nozzles for ejecting ink onto the printing medium are formed arranged in a first direction, a second head that is disposed at a position facing the image forming surface in the transport path and downstream of the first head in the transport direction of the printing medium and that includes a second nozzle row in which a plurality of nozzles for ejecting ink onto the printing medium are formed arranged in a second direction, a first head angle adjustment section including a first base plate, a first head holding section that is pivotable around a first pivot axis with respect to the first base plate in a state of holding the first head, and a first drive section that pivots the first head holding section around the first pivot axis, and configured to change a first inclination angle, which is an inclination angle of the first direction with respect to a direction orthogonal to the transport direction, a second head angle adjustment section including a second base plate, a second head holding section that is pivotable around a second pivot axis with respect to the second base plate in a state of holding the second head, and a second drive section that pivots the second head holding section around the second pivot axis, and configured to change a second inclination angle, which is an inclination angle of the second direction with respect to a direction orthogonal to the transport direction, and a control section, wherein the control section performs at least one of controlling the first drive section to pivot the first head holding section with respect to the first base plate or controlling the second drive section to pivot the second head holding section with respect to the second base plate such that the first inclination angle and the second inclination angle are different when an image is formed.

According to the aspect, the first head angle adjustment section that changes the first inclination angle and the second head angle adjustment section that changes the second inclination angle are provided. When an image is formed, at least one of controlling the first drive section to pivot the first head holding section with respect to the first base plate and controlling the second drive section to pivot the second head holding section with respect to the second base plate is performed so that the first inclination angle and the second inclination angle are different from each other. Therefore, for example, even when the printing medium is swollen by the ink ejected to the printing medium in accordance with the printing by the first head, the deviation of the landing position of the ink from the second head with respect to the landing position of the ink from the first head can be reduced by narrowing the printing width of the first head by increasing the inclination angle in the printing by the first head and widening the printing width of the second head by decreasing the inclination angle in the printing by the second head, even if the printing width becomes wider due to the swelling of the printing medium after the end of printing by the first head. Therefore, it is possible to suppress the occurrence of blurring or the like in an image because of the expansion and the contraction of the printing medium caused by the landing of ink.

A printing device of a fourth aspect of this disclosure, according to the third aspect, further includes a storage section, wherein the storage section stores the first inclination angle and the second inclination angle, which are determined in advance based on type of printing medium, ejection amount of ink ejected from each of the first head and the second head, and transport speed of the printing medium and the control section determines a first set inclination angle and a second set inclination angle from the first inclination angle and the second inclination angle stored in the storage section based on type of printing medium used in formation of the image, ejection amount of ink ejected from each of the first head and the second head in formation of the image, and transport speed of the printing medium in formation of the image, and controls the first drive section based on the first set inclination angle and controls the second drive section based on the second set inclination angle.

According to this aspect, the storage section stores the first and second inclination angles, which are determined in advance based on the type of printing medium, the ejection amount of ink ejected from each of the first and second heads, and the transport speed of the printing medium. The control section determines a first set inclination angle and a second set inclination angle from the first inclination angle and the second inclination angle stored in the storage section based on the type of printing medium used when forming an image, the ejection amount of ink ejected by each of the first head and the second head when forming an image, and the transport speed of the printing medium when forming an image, controls the first drive section based on the first set inclination angle, and controls the second drive section based on the second set inclination angle. That is, it is possible to easily and accurately determine the first set inclination angle and the second set inclination angle which are preferable by storing in advance in the storage section how much the printing medium expands and contracts due to the ink which is ejected onto the printing medium along with the printing in each of the first head and the second head. Therefore, it is possible to suppress the time and effort required by the user and the complexity of the control section's control.

In a fifth aspect of this disclosure, a printing method of a printing device including a head having a nozzle array in which a plurality of nozzles configured to eject ink onto a printing medium are arranged in a first direction, a movement mechanism that relatively moves the head and the printing medium when the ink is ejected onto the printing medium, and a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium, the printing method includes pivoting the head holding section with respect to the base plate such that the inclination angle is different between a first pass among the plurality of passes and a second pass different from the first pass among the plurality of passes when forming an image in a predetermined area of the printing medium with a plurality of passes.

According to this aspect, when an image is formed on a predetermined area of the printing medium in a plurality of passes using the printing device including the head angle adjustment section capable of changing the inclination angle, the head holding section is rotated with respect to the base plate such that the inclination angle is different between the first pass and the second pass among the plurality of passes. Therefore, for example, even if the printing medium swells due to ink ejected onto the printing medium in the first pass, increasing the inclination angle to narrow the printing width in the first pass in printing in the first pass and decreasing the inclination angle to widen the printing width in the second pass in printing in the second pass can reduce the displacement of the ink landing position in the second pass relative to the ink landing position in the first pass even if the printing width is widened due to the swelling of the printing medium after the end of printing in the first pass. Therefore, it is possible to suppress the occurrence of blurring or the like in an image because of the expansion and the contraction of the printing medium caused by the landing of ink.

### First Embodiment

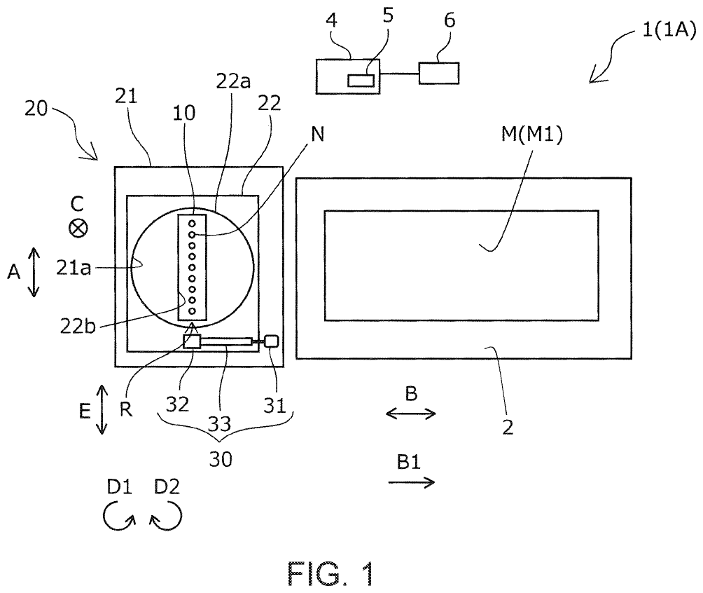

Below, with reference to the drawings, an embodiment according to the present disclosure will be specifically described. First, a printing device 1A of embodiment 1 as an example of a printing device 1 of the present disclosure will be described with reference to FIGS. 1 to 6.

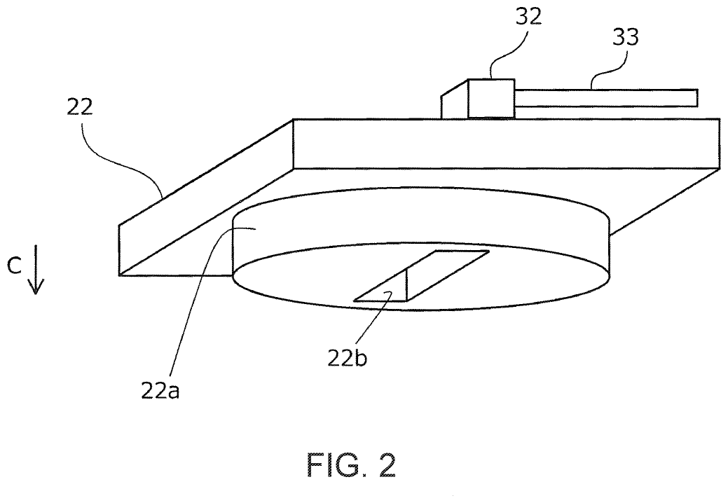

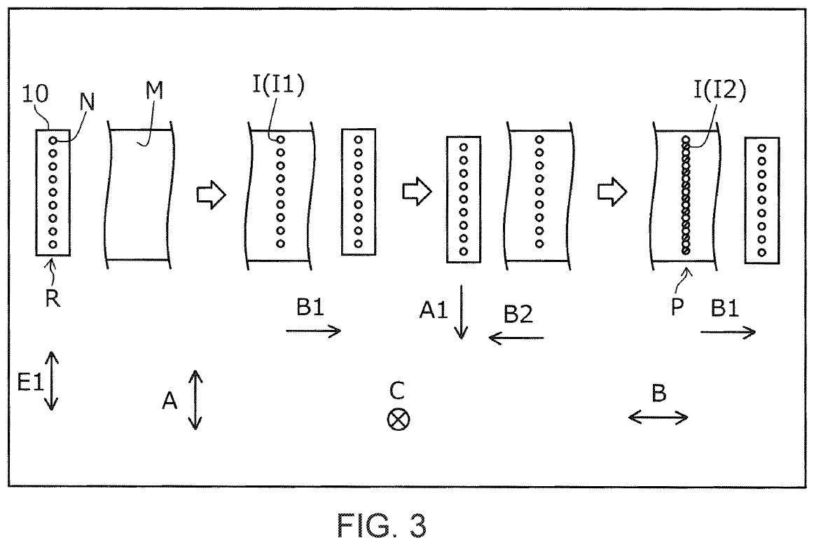

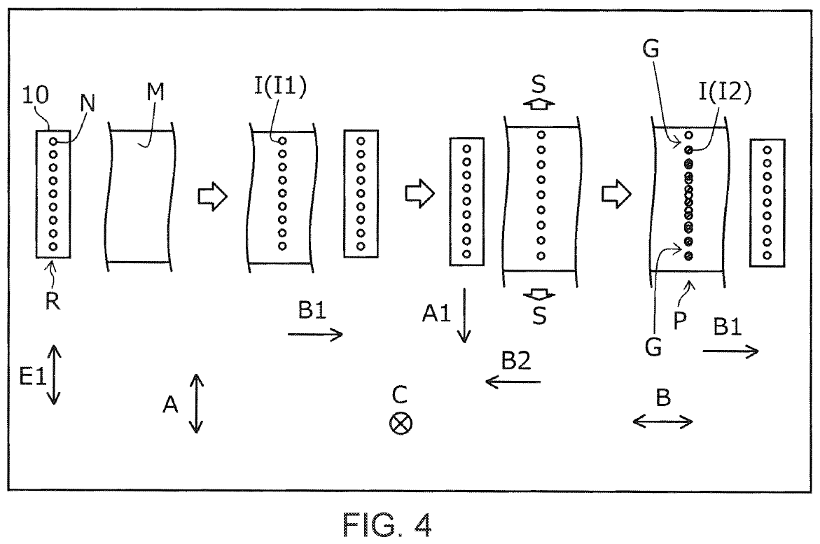

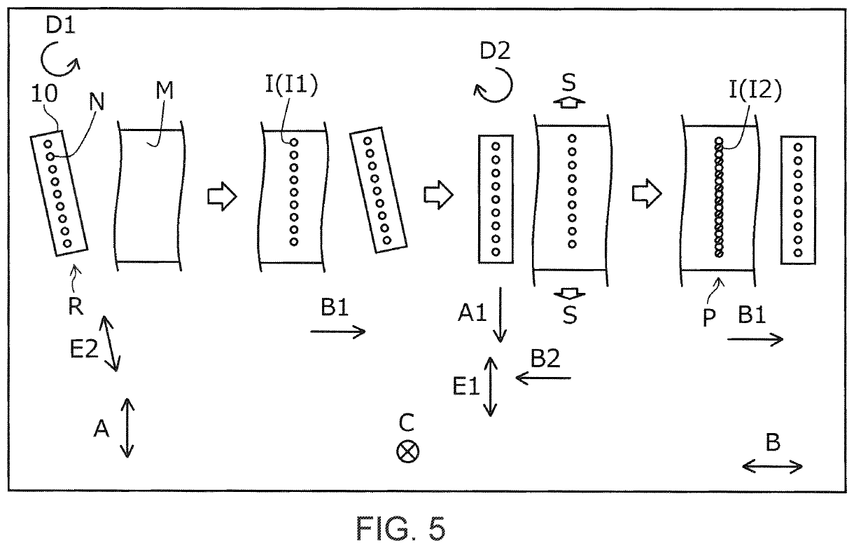

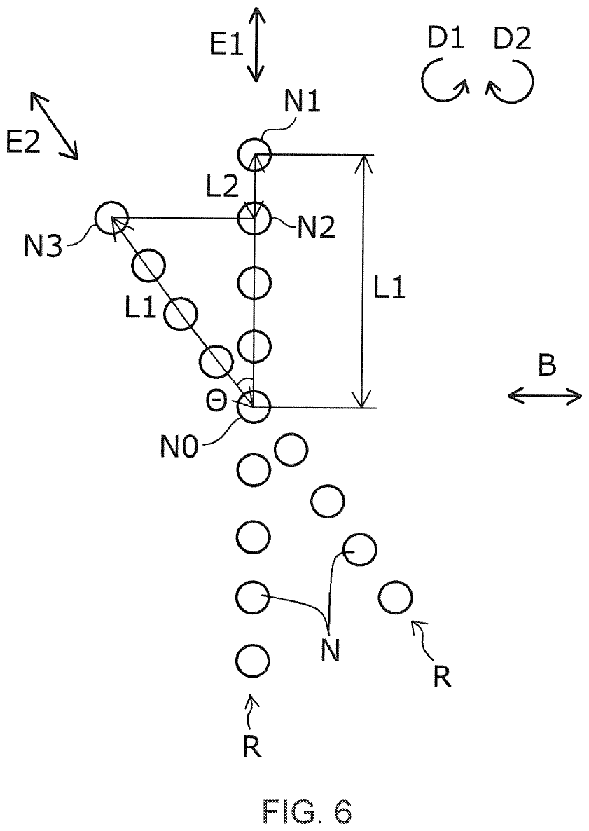

Here, FIG. 1 is a schematic plan view of the printing device 1A in the present embodiment and is a diagram illustrating positions of nozzles N as seen through a head 10. FIG. 2 is a schematic perspective view illustrating a head holding section 22 of the printing device 1A according to the present embodiment. FIG. 3 is a schematic diagram illustrating a state in which a linear pattern P is printed on a printing medium M that tends not to swell in the printing device 1A of the embodiment, and illustrates a formation state of the linear pattern P in a case where the inclination angle θ is 0°, which is the minimum, in both the first pass and the second pass, that is, in a case where a first direction E, which is the direction in which the nozzles N configuring the nozzle row R are arranged, is not changed in the first pass and the second pass. FIG. 4 is a schematic diagram illustrating a state in which the linear pattern P is printed on a printing medium M that tends to swell in the printing device 1A of the present embodiment, and illustrates a formation state of the linear pattern P in a case where the inclination angle θ is 0°, which is the minimum, in both the first pass and the second pass, that is, in a case where the first direction E which is the direction in which the nozzles N configuring the nozzle row R are arranged is not changed in the first pass and the second pass. FIG. 5 is a schematic diagram illustrating a state in which the linear pattern P is printed on a printing medium M that tends to swell in the printing device 1A of the present embodiment and illustrates a formation state of the linear pattern P in a case where the inclination angle θ is large in the first pass and the inclination angle θ is 0°, which is the minimum, in the second pass, that is, in a case where the first direction E, which is the direction in which the nozzles N configuring the nozzle row R are arranged, is changed between the first pass and the second pass. FIG. 6 is a diagram for explaining a method of determining the inclination angle θ in the printing device 1A of the present embodiment.

An outline of the printing device 1A in the present embodiment is described below with reference mainly to FIGS. 1 and 2. As shown in FIG. 1, the printing device 1A in the present embodiment includes a platen 2 that supports the printing medium M. As illustrated in FIG. 1, the printing device 1A of the present embodiment includes the head 10 having a plurality of nozzles N and capable of ejecting the ink I from the nozzles N toward a printing medium M in an ejection direction C. Here, the head 10 has a configuration for ejecting ink I from the nozzles N toward the printing medium M in the ejection direction C, which is illustrated in FIG. 3, and has a nozzle row R in which a plurality of nozzles N are formed side by side in the first direction E.

The printing device 1A of the present embodiment includes a carriage 20 in which the head 10 is mounted and which can move in the relative movement direction B at a position facing the image forming surface Ml of the printing medium M supported by the platen 2. A carriage motor 6 and the like are included as a movement mechanism that relatively moves the head 10 and the printing medium M when ink I is ejected onto the printing medium M. The printing device 1A of the present embodiment further includes a control section 4 that has a CPU (not illustrated) and a storage section 5 that stores various information and can store new information, and the carriage motor 6 is electrically coupled to the control section 4.

The carriage 20 includes a base plate 21, the head holding section 22, which is pivotable around a pivot axis with respect to the base plate 21 in a state of holding the head 10, and a drive section 30, which pivots the head holding section 22 around the pivot axis of the head holding section 22, and also serves as a head angle adjustment section, which can change an inclination angle θ of the first direction E with respect to a direction orthogonal to the relative movement direction B. To be specific, as shown in FIG. 2, the head holding section 22 has a cylindrical section 22a having a cylindrical shape when viewed from the direction along the ejection direction C, and the cylindrical section 22a includes a hole section 22b which supports the head 10 and exposes the nozzle row R of the head 10. Note that as shown in FIG. 1, the base plate 21 includes a circular hole section 21a into which the cylindrical section 22a is fitted.

The head holding section 22 has an adjustment screw block 32 and an adjustment screw 33 which constitute the drive section 30, and the adjustment screw 33 is coupled to a stepping motor 31 provided on the base plate 21. With this structure, driving the stepping motor 31 can change the position of the adjustment screw block 32 relative to the stepping motor 31, which can turn the head holding section 22 relative to the base plate 21 in the rotational directions D1 and D2. Note that when the head holding section 22 is pivoted with respect to the base plate 21, the pivot axis is the cylindrical section 22a and the hole section 21a. More specifically, the center of the pivot axis is the position of the nozzle NO at the center of the nozzle row R shown in FIG. 6.

Next, formation of an image in the printing device 1A of the present embodiment will be described mainly with reference to FIGS. 3 to 6. First, with reference to FIG. 3, a case is described in which the printing device 1A in the present embodiment prints a linear pattern P on a printing medium M that tends not to swell. Depending on the type, the printing medium M may swell, shrink, or neither swell nor shrink substantially when ink is applied thereto. The formation state of the linear pattern P illustrated in FIG. 3 is an example of a case where a medium that barely swells or shrinks even when ink is applied is used as the printing medium M.

The printing device 1A of the present embodiment is configured to form an image in two passes on a predetermined area of the printing medium M. A state shown in the leftmost part of FIG. 3, represents a state immediately before the ejection operation of ink I1 in the first pass is performed on the predetermined region of the printing medium M. Note that in the state shown in the leftmost part of FIG. 3, the first direction E, which is the direction in which the nozzles N constituting the nozzle row R are arranged, is the direction E1 in which the inclination angle θ is 0°. The ejection operation of ink I1 in a first pass is executed while the head 10 is moved together with the carriage 20 in the direction B1 of the relative movement direction B from the state shown in the leftmost part of FIG. 3.

The state shown in the second from the leftmost part of FIG. 3 represents the state immediately after the ejection operation of the ink I1 of the first pass is executed. The ink I ejected from each nozzle N constituting the nozzle row R is applied to a predetermined region of the printing medium M. Next, the state shown in the third from the leftmost part of FIG. 3 represents the state immediately before the ejection operation of the ink 12 of the second pass is executed. Specifically, from the state shown in the second from the leftmost part of FIG. 3, the head 10 is moved together with the carriage 20 in the direction B2 of the relative movement direction B, and further, the head 10 is moved together with the carriage 20 in the direction A1 of the width direction A of the printing medium M by one nozzle of the nozzles N constituting the nozzle row R. Note that even in the state shown in the third from the leftmost part of FIG. 3, the first direction E, which is the direction in which the nozzles N configuring the nozzle row R are arranged, is the direction E1 in which the inclination angle θ is 0°.

Then, the ejection operation of the ink 12 of the second pass is executed while moving the head 10 together with the carriage 20 in the direction B1 of the relative movement direction B from the state shown in the third from the leftmost part of FIG. 3. The state on the rightmost part of FIG. 3 represents a state immediately after the ejection operation of the ink 12 in the second pass is executed. When using as the printing medium M a printing medium that barely swells or shrinks even when ink is applied thereto, a preferable linear pattern P without blurring or the like is formed, as illustrated in the state on the rightmost part of FIG. 3.

Next, with reference to FIGS. 4 and 5, a case is described in which the linear pattern P is printed in the printing device 1A of the present embodiment on a printing medium M that easily swells. Here, FIG. 4 shows a case where printing is performed using the inclination angle θ set to 0°, and FIG. 5 shows a case where printing is performed using an inclination angle θ changed between the first and second passes according to the degree of swelling of the printing medium M. The state shown in leftmost part of FIG. 4 represents a state immediately before the ink ejection operation of the first pass is performed on the predetermined region of the printing medium M. Note that similar to the state shown in the leftmost part of FIG. 3, in the state shown in the leftmost part of FIG. 4, the first direction E in which the nozzles N comprising the nozzle row R are arranged is the direction E1 in which the inclination angle θ is 0°. While moving the head 10 together with the carriage 20 in the direction B1 of the relative movement direction B from the state shown in leftmost part of FIG. 4, the ejection operation of the ink I1 of the first pass is executed.

The state shown in the second from the leftmost part of FIG. 4 represents the state immediately after the ejection operation of the ink I1 of the first pass is executed. The ink I ejected from each nozzle N constituting the nozzle row R is applied to a predetermined region of the printing medium M. Next, the state shown in the third from the leftmost part of FIG. 4 represents a state immediately before the ejection operation of the ink 12 of the second pass is executed. Specifically, from the state shown in the second from the leftmost part of FIG. 4, the head 10 is moved together with the carriage 20 in the direction B2 of the relative movement direction B, and further, the head 10 is moved together with the carriage 20 in the direction A1 of the width direction A of the printing medium M by one nozzle of the nozzles N constituting the nozzle row R. Note that in the state shown in the third from the leftmost part of FIG. 4, the first direction E, which is the direction in which the nozzles N constituting the nozzle row R are arranged, is the direction E1 in which the inclination angle θ is 0°.

However, when the ink I1 is applied to a printing medium M that tends to swell, the printing medium M swells in the swelling directions S corresponding to the width direction A as is clear in the state shown in the third from the leftmost part of FIG. 4 by comparison with the state shown in the second from the leftmost part of FIG. 4 and the state shown in the third from the leftmost part of FIG. 3. Then, from the state shown in the third from the leftmost part of FIG. 4, the head 10 is moved in the direction B1 of the relative movement direction B together with the carriage 20, and the ejection operation of the ink 12 of the second pass is executed. The state on the rightmost part of FIG. 4 represents a state immediately after the ejection operation of the ink 12 in the second pass is executed. When a medium that easily swells when applied with ink is used as the printing medium M, as illustrated in the state on the rightmost part of FIG. 4, there is a risk that a gap G is formed, particularly at an end portion in the width direction A, and that a blurred linear pattern P is formed.

Therefore, in order to suppress formation of such a blurred linear pattern P in the printing device 1A of the present embodiment, the first direction E, which is the direction in which the nozzles N are arranged, can be changed between the first and second passes. The state shown in the leftmost part of FIG. 5 represents a state immediately before the ink ejection operation of the first pass is performed on a predetermined region of the printing medium M. Note that unlike the state shown in the leftmost part of FIG. 3 or the state shown in the leftmost part of FIG. 4, in the leftmost state of FIG. 5, the first direction E in which the nozzles N constituting the nozzle row R are aligned is the direction E2 in which the inclination angle θ is greater than 0°. By setting the first direction E to a direction E2, the lengths of the linear patterns P in the width direction A, as viewed from the relative movement direction B, are shortened. Then, while moving the head 10 together with the carriage 20 in the direction B1 of the relative movement direction B from the state shown in leftmost part of FIG. 5, the ejection operation of the ink I1 of the first pass is executed.

The state shown in the second from the leftmost part of FIG. 5 represents a state immediately after the ejection operation of the ink I1 of the first pass is executed. The ink I ejected from each nozzle N constituting the nozzle row R is applied to a predetermined region of the printing medium M. However, as described above, the length of the linear pattern P in the width direction A when viewed from the relative movement direction B is shorter than that in the state shown in the second from the leftmost part of FIG. 3 or the state shown in the second from the leftmost part of FIG. 4. Next, the state shown in the third from the leftmost part of FIG. 5 represents a state immediately before the ejection operation of the ink 12 of the second pass is executed. Specifically, from the state shown in the second from the leftmost part of FIG. 5, the head 10 is moved together with the carriage 20 in the direction B2 of the relative movement direction B, and further, the head 10 is moved together with the carriage 20 in the direction A1 of the width direction A of the printing medium M by one nozzle of the nozzles N constituting the nozzle row R. Note that in the state shown in the third from the leftmost part of FIG. 5, the first direction E which is the direction in which the nozzles N constituting the nozzle row R are arranged is the direction E1 in which the inclination angle θ is 0°.

However, when the ink I1 is applied to a printing medium M that easily swells, the printing medium M swells in the swelling direction S corresponding to the width direction A even in the state shown in the third from the leftmost part of FIG. 5. By doing this, the length of the linear pattern P in the width direction A as viewed from the relative movement direction is equal to the length of the linear pattern P in the width direction A as viewed from the relative movement direction in the state shown in the third from the leftmost part of FIG. 3. This is because the degree of swelling of the printing medium M when the ink I is applied to the printing medium M is examined in advance, and the direction E2 is set according to the degree of swelling. Then, the ejection operation of the ink 12 of the second pass is executed while moving the head 10 together with the carriage 20 in the direction B1 of the relative movement direction B from the state shown in the third from the leftmost part of FIG. 5. The state on the rightmost part of FIG. 5 represents a state immediately after the ejection operation of the ink 12 of the second pass is executed. Despite using a printing medium that easily swells when ink is applied thereto as the printing medium M, a preferable linear pattern P is formed, as illustrated the state on the rightmost part of FIG. 5.

As described above, the printing device 1A of the present embodiment can pivot the head holding section 22 with respect to the base plate 21 so that the inclination angle θ in the first direction E is different between the first pass among the plurality of passes and the second pass, which is different from the first pass, among the plurality of passes when images are formed in the plurality of passes on the predetermined region of the printing medium M. Note that at this time, the control of the entire apparatus is performed by the control section 4.

For example, as described above, even in a case where the printing medium M swells due to the ink ejected to the printing medium M in the printing of the first pass, the deviation of the landing position of the ink 12 in the second pass from the landing position of the ink I1 in the first pass can be reduced even if the printing width becomes wider due to the swelling of the printing medium M after the completion of the printing of the first pass by narrowing the printing width of the first pass by increasing the inclination angle θ in the first direction E in the printing of the first pass and widening the printing width of the second pass by decreasing the inclination angle θ in the first direction E in the printing of the second pass. In other words, the printing device 1A of the present embodiment is configured to reduce the deviation of the landing position of the ink I by performing printing with a smaller inclination angle θ in a later pass than in an earlier pass when the printing is performed on a printing medium M that easily swells. Therefore, the printing device 1A of the present embodiment can suppress the occurrence of blurring or the like in the image due to the expansion and the shrinkage of the printing medium M caused by the landing of the ink I.

Here, the printing device 1A of the present embodiment can form an image on the printing medium M in two passes, as described above, but can also form an image on the printing medium M in four and six passes. In this case, the first and second paths may be any path as long as they are different paths. In the above description, the first pass is set as the first pass, and the second pass is set as the second pass, but this may be considered to be opposite, and further, for example, in a case where an image is formed on the printing medium M even in four passes and six passes, the first pass may be set as the third pass, the second pass may be set as the fourth pass, and the like. That is, it is sufficient that in at least two passes of the plurality of passes, when printing on a printing medium M that easily swells, printing can be performed with the inclination angle @ made smaller in the later pass than in the earlier pass, and when printing on the printing medium M that easily contracts, printing can be performed with the inclination angle @ made larger in the later pass than in the earlier pass.

Hereinafter, a method of determining the inclination angle θ in the first direction E in the printing device 1A of the present embodiment will be described with reference to FIG. 6. Note that the printing device 1A of the present embodiment can form an image under various printing conditions. Specifically, it is possible to form an image on a plurality of types of printing medium M, it is possible to form an image on the printing medium M with a plurality of types of number of passes, and it is possible to form an image on the printing medium M by changing the ejection amount of the ink I that is discharged per pass. Here, the number of passes represent how many passes in which ink is ejected per unit area. In other words, the number of passes show how many passes are used to form a unit area of an image. In the printing device 1A of the present embodiment, the degree of expansion and contraction of the printing medium M in the width direction A is stored in the storage section 5 for each combination of the printing conditions, and the inclination angle θ of the first direction E corresponding to the degree of expansion and contraction is stored.

FIG. 6 corresponds to FIG. 5, and shows a direction E2, which is the first direction E of the first pass, and a direction E1, which is the first direction E of the second pass, in a case where an image is formed in two passes and, in association with the ejection of the ink I to the printing medium M in the first pass, the printing medium M extends in the width direction A by a distance L2 from the center position in the width direction A. Here, distance from the nozzle NO, which is the central position in the width direction A, to the nozzle N1 and to the nozzle N3 at the end portions in the width direction A are defined as distance L1. At the time of printing in the second pass, the image printed in the first pass extends in the width direction A by the distance L2 from the nozzle NO to the nozzle N1, so it is sufficient that the first direction E be set such that the first pass is shorter than the second pass in the width direction A by the distance L2. In FIG. 6, a nozzle N2 is the nozzle N located in a direction toward the nozzle NO from the nozzle N1 by a distance L2 when the first direction E is defined as the direction E1 that forms an angle of 0° with respect to the direction orthogonal to the relative movement direction B. Therefore, the direction E2 should be defined such that nozzle N1 is located at the same position as the nozzle N2 with respect to the relative movement direction B. Here, an angle formed by straight lines sequentially connecting the nozzle N2, the nozzle NO, and the nozzle N3 corresponds to the inclination angle θ. Then, L2 can be represented as L1-L1 cos θ. From such a relationship, it is possible to calculate the inclination angle θ of the first direction E by grasping in advance the expansion and contraction distance of the printing medium M when the ink I is ejected.

In the storage section 5 of the printing device 1A of the present embodiment, the inclination angle θ in the first direction E, which is predetermined based on the type of the printing medium M, the ejection amount of the ink I ejected per pass, and the number of passes, is stored corresponding to each pass. Then, based on these printing conditions, the control section 4 determines a set inclination angle to be set at the time of forming an image from the inclination angle θ in the first direction E stored in the storage section 5, and controls the drive section 30 based on the set inclination angle. Note that the set inclination angle corresponding to FIG. 5 and FIG. 6 is an angle corresponding to the direction E2 in the first pass, and is 0° as an angle corresponding to the direction E1 in the second pass. As described above, the degree of expansion and contraction of the printing medium M due to the ink I ejected onto the printing medium M along with the printing of the first pass is stored in advance in the storage section 5 for each of the first pass and the second pass for each of the conditions described above, and thus it is possible to easily and accurately determine a preferable set inclination angle. Therefore, it is possible to suppress the time and effort required by the user and the complication of the control of the control section 4.

Here, Table 1 shows a table indicating inclination angles θ of the first direction E for each pass. The inclination angles θ are determined in advance based on the type of the printing medium M, the ejection amount of the ink I ejected per pass, and the number of passes, and are stored in the storage section 5 of the printing device 1A of the present embodiment. Note that depending on the type of the printing medium M, some printing medium M easily expand or contract and some tend not to expand or contract. When the ejection amount of the ink I is large, the printing medium M tends to expand or contract. Since an ejection amount of ink I ejected per pass increases when the number of passes is small, the printing medium M is likely to expand and contract.

TABLE 1

| | EJECTION | | | | | | | |
|---|---|---|---|---|---|---|---|---|
| TYPE OF | AMOUNT | | INCLINATION ANGLE [°] | | | | | |
| PRINTING | PER PASS | NUMBER | 1ST | 2ND | 3RD | 4TH | 5TH | 6TH |
| MEDIUM | [mg/inch2] | OF PASSES | PASS | PASS | PASS | PASS | PASS | PASS |
| PAPER | 7.2 TO 14.4 | 6 | 12 | 7 | 3 | 0 | 0 | 0 |
| PAPER | <7.2 | 6 | 6 | 3 | 0 | 0 | 0 | 0 |
| FILM | <14.4 | 6 | 0 | 0 | 0 | 2 | 2 | 4 |
| PAPER | 7.2 TO 14.4 | 4 | 17 | 12 | 7 | 3 | | |

Although Table 1 is an example, when the type of the printing medium M is paper, the ejection amount of the ink I ejected per one pass is 7.2 to 14.4 mg/inch², and the number of passes is six, then the inclination angle θ of the first direction E is 12° in the first pass, 7° in the second pass, 3° in the third pass, and 0° in the fourth to sixth passes. When the type of the printing medium M is paper, the ejection amount of the ink I ejected per one pass is less than 7.2 mg/inch², and the number of passes is six, then the inclination angle θ of the first direction E is set to 6° in the first pass, the inclination angle θ of the first direction E is set to 3° in the second pass, and the inclination angle θ of the first direction E is set to 0° in the third to sixth passes. When the type of the printing medium M is film, the ejection amount of the ink I ejected per one pass is less than 14.4 mg/inch², and the number of passes is six, then the inclination angle θ of the first direction E is 0° in the first to third passes, the inclination angle θ of the first direction E is 2° in the fourth pass, the inclination angle θ of the first direction E is 2° in the fifth pass, and the inclination angle of the first direction E is 4° in the sixth pass. This is because the film has a characteristic of contracting to a small extent when the ink is ejected. When the type of the printing medium M is paper, the ejection amount of the ink I ejected per pass is 7.2 to 14.4 mg/inch², and the number of passes is four, then the inclination angle θ of the first direction E is 17° in the first pass, the inclination angle θ of the first direction E is 12° in the second pass, the inclination angle θ of the first direction E is 7° in the third pass, and the inclination angle θ of the first direction E is 3° in the fourth pass.

### Second Embodiment

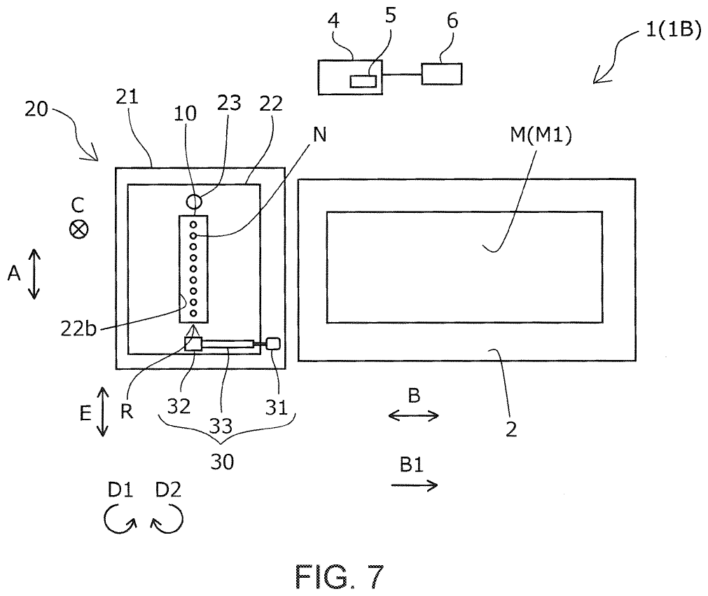

Next, a printing device 1B according to a second embodiment will be described with reference to FIG. 7. Note that FIG. 7 is a diagram corresponding to FIG. 1 in the printing device 1A of the first embodiment. In FIG. 7, components common to those of the first embodiment are denoted by the same reference numerals, and a detailed description thereof will be omitted. Here, the printing device 1B of the present embodiment has the same configuration as the printing device 1A of the first embodiment, except for the configuration of the portion described below. Therefore, the printing device 1B of the present embodiment has the same features as those of the printing device 1A of the first embodiment, except for the parts described below.

As described above, in the printing device 1A of the first embodiment, the pivot axis when the head holding section 22 is pivoted with respect to the base plate 21 is the cylindrical section 22a and the hole section 21a. Therefore, in the printing device 1A of the first embodiment, the position of the nozzle NO is the center position of the pivot axis. On the other hand, as illustrated in FIG. 7, the printing device 1B of the present embodiment includes a pivot axis 23 when the head holding section 22 is pivoted with respect to the base plate 21. Note that a hole section (not shown) is also formed in the base plate 21 of the printing device 1B of the present embodiment at positions where the nozzles N face the printing medium M, similar to the printing device 1A of the first embodiment. The position of the pivot axis 23 is different from the position of the nozzle row R. As described above, the shape and the position of the pivot axis are not particularly limited.

### Third Embodiment

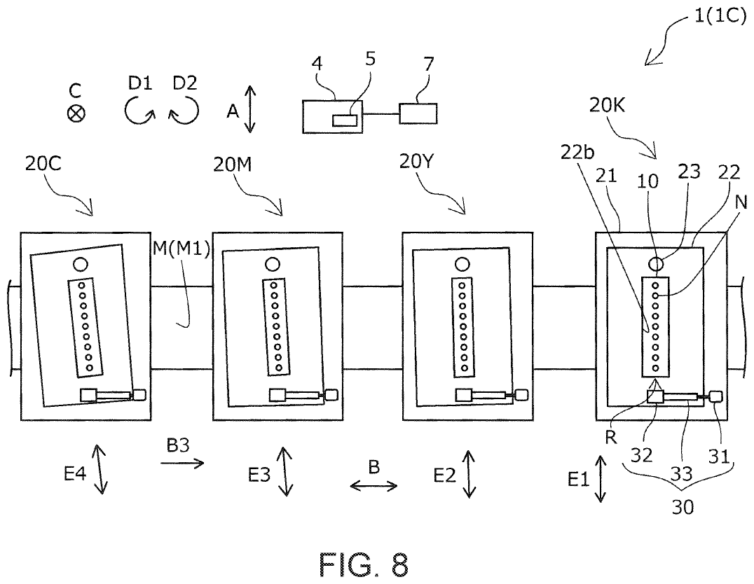

Next, a printing device 1C according to a third embodiment will be described with reference to FIG. 8. Note that FIG. 8 is a diagram corresponding to FIG. 1 in the printing device 1A of the first embodiment. In FIG. 8, components common to those of the first and second embodiments are denoted by the same reference numerals, and a detailed description thereof is omitted. Here, the printing device 1C of the present embodiment has the same configuration as the printing device 1 of the first and second embodiments, except for the configuration of the portion described below. Therefore, the printing device 1C of the present embodiment has the same features as those of the printing device 1 of the first and second embodiments, except for the parts described below.

As described above, the printing devices 1 of the first and second embodiments are configured to perform printing by moving the carriage 20, on which the head 10 is mounted, in the directions B1 and B2 of the relative movement direction B with respect to the printing medium M supported by the platen 2 by driving the carriage motor 6. On the other hand, the printing device 1C of this embodiment is configured to print by moving the printing medium M in the transport direction B3 of the relative movement direction B relative to the carriage 20 by driving a transport motor 7 instead of moving the carriage 20 on which the head 10 is mounted.

As illustrated in FIG. 8, the printing device 1C of the present embodiment includes, as the carriage 20, a carriage 20C on which the head 10 for ejecting cyan ink is mounted, a carriage 20M on which the head 10 for ejecting magenta ink is mounted, a carriage 20Y on which the head 10 for ejecting yellow ink is mounted, and a carriage 20K on which the head 10 for ejecting black ink is mounted. In detail, carriages 20C, 20M, 20Y, and 20K are arranged in this order from upstream to downstream in the transport direction B3. Note that all of the carriages 20C, 20M, 20Y, and 20K have the same configuration as the carriage 20 of the printing device 1B of the second embodiment except that they do not move in the relative movement direction B along the transport direction B3.

That is, the printing device 1C of the present embodiment includes the transport motor 7 constituting a transport section to transport the printing medium M, and a plurality of heads 10 disposed at positions opposing the image forming surface Ml of the printing medium M in the transport path of the printing medium M. In concordance with each head 10, there is provided the carriage 20 that has the base plate 21, the head holding section 22 pivotable about the pivot axis 23 with respect to the base plate 21 in a state of holding the head 10, and the drive section 30 for pivoting the head holding section 22 about the pivot axis 23 and that serves as a head angle adjustment section capable of changing the inclination angle θ.

Here, the printing device 1C according to the present embodiment can be expressed as including, as the head 10, a first head having a first nozzle row in which a plurality of nozzles N ejecting the ink I to the printing medium M are arranged in the first direction, and a second head which is disposed on the downstream side of the first head in the transport direction B3 and has a second nozzle row in which a plurality of nozzles N ejecting the ink I to the printing medium M are arranged in the second direction. For example, when the head 10 of the carriage 20C is defined as a first head, the heads 10 of the carriages 20M, 20Y, and 20K can be regarded as second heads. Similarly, in a case where the head 10 of the carriage 20M is defined as the first head, the heads of the carriages 20Y and 20K can be regarded as the second head, and in a case where the head 10 of the carriage 20Y is defined as the first head, the head 10 of the carriage 20K can be regarded as the second head.

The printing device 1C according to the present embodiment can be expressed as the carriage 20 including a first base plate, a first head holding section pivotable about a first pivot axis with respect to the first base plate in a state of holding the first head, a first drive section for pivoting the first head holding section about the first pivot axis, a first head angle adjustment section for changing the first inclination angle as the inclination angle θ in in addition to a second base plate, a second head holding section pivotable about a second pivot axis with respect to the second base plate in a state of holding the second head, a second drive section for pivoting the second head holding section about the second pivot axis, and a second head angle adjustment section for changing the second inclination angle as the inclination angle θ. For example, in a case where the head 10 of the carriage 20C is defined as the first head angle adjustment section, the heads 10 of the carriage 20M, 20Y, and 20K can be considered as the second head angle adjustment section. Similarly, when the head 10 of the carriage 20M is defined as the first head angle adjustment section, the heads 10 of the carriages 20Y and 20K can be regarded as the second head angle adjustment section, and when the head 10 of the carriage 20Y is defined as the first head angle adjustment section, the head 10 of the carriage 20K can be regarded as the second head angle adjustment section.

When forming an image, the control section 4 in the printing device 1C of the present embodiment can perform at least one of controlling the first drive section to pivot the first head holding section with respect to the first base plate and controlling the second drive section to the second head holding section with respect to the second base plate so that the first and second inclination angles are different from each other. For example, in FIG. 8, by the control of the control section 4, in each carriage 20, the inclination angle θ is arranged so as to become smaller as the direction E corresponding to the direction in which the nozzles N constituting the nozzle array R are arranged becomes the direction E4 of the carriage 20C, the direction E3 of the carriage 20M, the direction E2 of the carriage 20Y, and the direction E1 of the carriage 20K.

Because the printing device 1C of the present embodiment has such a configuration, for example, even in a case where the printing medium M swells due to the ink I ejected onto the printing medium M in accordance with printing by the first head, it is possible to narrow the printing widths by the first head by increasing the inclination angle θ at the time of printing by the first head, and to widen the printing widths by the second head by decreasing the inclination angle θ at the time of printing by the second head. In this way, even if the print width becomes wider due to swelling of the printing medium M after completion of printing by the first head, the deviation of the landing position of the ink from the second head with respect to the landing position of the ink from the first head can be reduced. In other words, when the printing device 1C of the present embodiment prints on a printing medium M that is likely to swell, the head 10 downstream in the transport direction B3 prints with a smaller inclination angle θ than the head 10 upstream in the transport direction B3, thus achieving a configuration capable of reducing the displacement of the landing position of the ink I. Therefore, the printing device 1C of the present embodiment can suppress the occurrence of blurring or the like in the image due to the expansion and contraction of the printing medium caused by the landing of ink.

Here, as described above, the printing device 1C of the present embodiment has a configuration capable of forming an image on the printing medium M by the four heads 10, but may have a configuration capable of forming an image on the printing medium M by two or three heads 10, or five or more heads 10. In this case, the first and second heads may be any head 10 as long as they are different heads 10. That is, in at least two heads 10 of the plurality of heads 10, a head 10 downstream in the transport direction B3 can perform printing at a smaller inclination angle θ than a head 10 upstream in the transport direction B3 when printing on a printing medium M that easily swells, and the head 10 downstream in the transport direction B3 can perform printing at a larger inclination angle θ than the head 10 upstream in the transport direction B3 when printing on a printing medium M that easily shrinks.

The printing device 1C of the present embodiment is provided with the storage section 5, which stores the first and second inclination angles that are predetermined based on printing conditions, including the type of the printing medium M, the ejection amount of the ink I ejected by each of the first and second heads, and the transport speed of the printing medium M. Based on these printing conditions, the control section 4 can determine the first and second set inclination angles from the first and second inclination angles stored in the storage section 5, control the first drive section based on the first set inclination angle, and control the second drive section based on the second set inclination angle. In the printing device 1C of the embodiment, the degree of expansion and contraction of the printing medium M due to the ink I ejected onto the printing medium M in accordance with printing by each of the first and second heads is stored in the storage section 5 in advance, and it is possible to easily and accurately determine the preferred first and second set inclination angles. Therefore, the printing device 1C of the present embodiment can suppress the time and effort required by the user and the complication of the control of the control section 4.

Table 2 shows a table indicating the inclination angle θ in each head 10, which is determined in advance based on the type of the printing medium M, the ejection amount of the ink I ejected per head, and the printing speed, which are stored in the storage section 5 of the printing device 1C of the present embodiment. Note that the first head corresponds to the head 10 of the carriage 20C, the second head corresponds to the head 10 of the carriage 20M, the third head corresponds to the head 10 of the carriage 20Y, and the fourth head corresponds to the head 10 of the carriage 20K. Note that when the printing speed is slow, the time during which the printing medium M expands and contracts is longer, and thus the printing medium M easily expands or contracts.

TABLE 2

| TYPE OF | EJECTION | PRINTING | INCLINATION ANGLE [°] | | | |
|---|---|---|---|---|---|---|
| PRINTING | AMOUNT | SPEED | 1ST | 2ND | 3RD | 4TH |
| MEDIUM | [mg/inch²] | [m/min] | HEAD | HEAD | HEAD | HEAD |
| PAPER | 14.4 | 7.5 | 12 | 7 | 3 | 0 |
| PAPER | 20 | 7.5 | 16 | 10 | 5 | 0 |
| PAPER | 14.4 | 30 | 6 | 3 | 0 | 0 |
| PAPER | 14.4 | 50 | 3 | 3 | 0 | 0 |

Although Table 2 is an example, in a case where the type of the printing medium M is paper, the ejection amount of the ink I ejected per head is 14.4 mg/inch², and the printing speed is 7.5 m/min, then the inclination angle θ of the first head is 12°, the inclination angle θ of the second head is 7°, the inclination angle θ of the third head is 3°, and the inclination angle θ of the fourth head is 0°. When the type of the printing medium M is paper, the ejection amount of the ink I ejected per head is less than 20 mg/inch², and the printing speed is 7.5 m/min, then the inclination angle θ is set to 16° for the first head, 10° for the second head, 5° for the third head, and 0° for the fourth head. In a case where the type of the printing medium M is paper, the ejection amount of the ink I ejected per head is 14.4 mg/inch², and the printing speed is 30 m/min, then the inclination angle θ is set to 6° for the first head, 3° for the second head, and 0° for the third and fourth heads. When the type of printing medium M is paper, the ejection amount of ink I ejected per head is 14.4 mg/inch², and the printing speed is 50 m/min, then the inclination angle θ is set to 3° for the first head, 3° for the second head, and 0° for the third and fourth heads.

The present disclosure is not limited to the above-described embodiments, and can be realized by various configurations without departing from the scope of the disclosure. For example, the technical features in the embodiments corresponding to the technical features in each aspect described in the summary of the disclosure can be appropriately replaced or combined in order to solve a part or all of the problems described above or in order to achieve a part or all of the effects described above. If the technical features are not described as essential in this specification, the technical features can be appropriately deleted.

What is claimed is:

1. A printing device comprising:
a head including a nozzle array in which a plurality of nozzles configured to eject ink onto a printing medium are arranged in a first direction;
a movement mechanism that relatively moves the head and the printing medium when ink is ejected onto the printing medium;
a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium; and
a control section, wherein
the control section controls the drive section to rotate the head holding section with respect to the base plate such that, when forming an image in a predetermined area of the printing medium with a plurality of passes, the inclination angle is different between a first pass of the plurality of passes and a second pass different from the first pass of the plurality of passes.

2. The printing device, according to claim 1, further comprising:
a storage section, wherein
the storage section stores, for each of the first and second passes, an inclination angle determined in advance based on type of printing medium, an ejection amount of ink to be ejected per pass, and a number of passes representing how many passes in which ink is ejected per unit area and
the control section determines a set inclination angle, from the inclination angles stored in the storage section, based on the type of printing medium to be used in formation of the image, the ejection amount of ink to be ejected per pass in formation of the image, and the number of passes in formation of the image, and controls the drive section based on the set inclination angle.

3. A printing device comprising:
a transport section that transports printing medium;
a first head that is disposed at a position facing an image forming surface of the printing medium in a transport path of the printing medium and that includes a first nozzle row in which a plurality of nozzles for ejecting ink onto the printing medium are formed arranged in a first direction;
a second head that is disposed at a position facing the image forming surface in the transport path and downstream of the first head in the transport direction of the printing medium and that includes a second nozzle row in which a plurality of nozzles for ejecting ink onto the printing medium are formed arranged in a second direction;
a first head angle adjustment section including a first base plate, a first head holding section that is pivotable around a first pivot axis with respect to the first base plate in a state of holding the first head, and a first drive section that pivots the first head holding section around the first pivot axis, and configured to change a first inclination angle, which is an inclination angle of the first direction with respect to a direction orthogonal to the transport direction;
a second head angle adjustment section including a second base plate, a second head holding section that is pivotable around a second pivot axis with respect to the second base plate in a state of holding the second head, and a second drive section that pivots the second head holding section around the second pivot axis, and configured to change a second inclination angle, which is an inclination angle of the second direction with respect to a direction orthogonal to the transport direction; and
a control section, wherein
the control section performs at least one of controlling the first drive section to pivot the first head holding section with respect to the first base plate or controlling the second drive section to pivot the second head holding section with respect to the second base plate such that the first inclination angle and the second inclination angle are different when an image is formed.

4. The printing device, according to claim 3, further comprising:
a storage section, wherein
the storage section stores the first inclination angle and the second inclination angle, which are determined in advance based on type of printing medium, ejection amount of ink ejected from each of the first head and the second head, and transport speed of the printing medium and
the control section determines a first set inclination angle and a second set inclination angle from the first inclination angle and the second inclination angle stored in the storage section based on type of printing medium used in formation of the image, ejection amount of ink ejected from each of the first head and the second head in formation of the image, and transport speed of the printing medium in formation of the image, and controls the first drive section based on the first set inclination angle and controls the second drive section based on the second set inclination angle.

5. A printing method of a printing device including
a head having a nozzle array in which a plurality of nozzles configured to eject ink onto a printing medium are arranged in a first direction,
a movement mechanism that relatively moves the head and the printing medium when the ink is ejected onto the printing medium, and
a head angle adjustment section including a base plate, a head holding section that is pivotable around a pivot axis with respect to the base plate in a state of holding the head, and a drive section that pivots the head holding section around the pivot axis, and configured to change an inclination angle of the first direction with respect to a direction orthogonal to a relative movement direction of the head and the printing medium,
the printing method comprising:
pivoting the head holding section with respect to the base plate such that the inclination angle is different between a first pass among the plurality of passes and a second pass different from the first pass among the plurality of passes when forming an image in a predetermined area of the printing medium with a plurality of passes.
